(19) United States
(12) Patent Application Publication
(10) Pub. No.: US 2005/0063895 A1
(43) Pub. Date: Mar. 24, 2005

(54) Production of potassium monopersulfate triple salt using oleum

(76) Inventor: Perry L. Martin, Yuba City, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 10/878,898

(22) Filed: Jun. 28, 2004

Related U.S. Application Data
(60) Provisional application No. 60/505,466, filed on Sep. 23, 2003.

(51) Int. Cl. C01B 15/08

(52) U.S. Cl. 423/513

(57) ABSTRACT

A method of preparing a potassium monopersulfate composition is presented, wherein the potassium monopersulfate composition has the formula (KHSO₅)ₓ(KHSO₄)_{y}(K₂ SO₄)_{z}, where x+y+z=1 and x=0.46−0.64, y=0.15−0.37, and z=0.15−0.37, said potassium monopersulfate composition having an active oxygen content greater than or equal to 4.9 wt. % and K₂S₂O₈ at a concentration of <0.5 wt. % of the potassium monopersulfate composition. The method includes reacting an H₂O₂ solution containing at least 70 wt. % H₂O₂ with oleum at a substoichiometric ratio of oleum to H₂O₂ to generate a weak Caro's acid solution, then combining the weak Caro's acid solution with an H₂SO₄ solution to produce a rich Caro's acid solution. The rich Caro's acid solution may be combined with an alkali potassium compound to produce the potassium monopersulfate composition. The temperature is preferably maintained at below 30° C. during the process.

### RELATED APPLICATION

This application claims the benefit of U.S. Provisional Application Ser. No. 60/505,466 filed on Aug. 13, 2003 under 35 U.S.C. § 119(e) and incorporates by reference the content of the provisional application in its entirety.

### FIELD OF TECHNOLOGY

The invention pertains generally to production of potassium monopersulfate and particularly to production potassium monopersulfate having low oxodisulfate byproduct.

### BACKGROUND

Potassium monopersulfate (KHSO₅), also known as potassium peroxymonosulfate, is a component of a triple salt with the formula 2 KHSO₅—KHSO₄—K₂SO₄. Due to the high oxidation potential of potassium monopersulfate (“PMPS”), the PMPS triple salt 2 KHSO₅—KHSO₄—K₂SO₄ makes a good candidate as a component in bleaches, cleansing agents, detergents, and etching agents, and also as an oxidizing agent in inorganic reactions.

While PMPS's strong oxidation potential is well known, PMPS is limited in its utility because of the presence of an irritating byproduct, K₂S₂O₈. The severe irritating qualities of K₂S₂O₈ and its inherent stability relative to the desirable KHSO₅ limit the use of PMPS to products that would not come in contact with its users. Thus, while PMPS could be used in personal care products, manufacturers do not use PMPS for the fear that users of these products will experience irritation from the K₂S₂O₈. The irritating effects of K₂S₂O₈ even limit the use of PMPS in products that come into contact with users (and their pets) indirectly, such as surface cleaners, laundry bleaching agents, and swimming pool water treatment solutions. Even low levels of K₂S₂O₈ accumulated in pool water or laundry as residues can cause undesirable effects on humans and pets that come into contact with it. Ideally, to be able to use PMPS in these products, the level of K₂S₂O₈ as a byproduct should be <0.1 wt. % of the PMPS.

One way to reduce or eliminate the fraction of K₂S₂O₈ in a PMPS product is to increase the yield and stability of the desirable KHSO₅ without using oleum, since the use of oleum results in the production of K₂S₂O₈. Since a higher active oxygen content in the end product correlates with a higher fraction of KHSO₅, it is desirable to achieve a PMPS composition with increased active oxygen content and higher stability using H₂SO₄. Publicly available Caro's acid conversion data (e.g., data from FMC Corporation) indicates that with H₂SO₄ to H₂O₂ molar ratios of 1:1 and 2:1, the active oxygen obtained from the Caro's acid equilibrium products yields 4.3% and 3.7%, respectively.

Typically, PMPS triple salt is produced by using Caro's acid (H₂SO₅, also called peroxymonosulphuric acid). Caro's acid is usually produced by reacting H₂SO₄ or oleum with H₂O₂. More specifically, Caro's acid is an equilibrium product between these reactants on one hand and H₂SO₅ and H₂O on the other, as shown by the following reaction:
H₂SO₄+H₂O₂<< >>H₂SO₅ (Caro's acid)+H₂O.
As the molar ratio of H₂SO₄ to H₂O₂ increases, the yield of H₂SO₅ increases. Thus, in order to optimize the amount of Caro's acid that is produced, excess H₂SO₄ or oleum is added during the process.

The Caro's acid is reacted with alkali potassium salts such as KHCO₃, K₂CO₃, and/or KOH to generate KHSO:
H₂SO₅+KOH→KHSO₅+H₂O.
Thus, increasing the yield of Caro's acid results in a higher concentration of KHSO₅, which helps reduce formation of the irritant K₂S₂O₈. The potassium to sulfur ratio (K/S) is controlled to produce a specific composition. Generally, a K/S of <1.0 will result in a high yield of KHSO₅ because K/S>1.0 induces some attrition of the desired salt to produce K₂SO₄.

However, the salt resulting from K/S<1.0 is too unstable for most commercial applications and is hygroscopic. To make a stable, non-hygroscopic triple salt, a sufficient level of K/S must be achieved to produce the stabilizing sulfate salts (i.e., KHSO₄ and K₂SO₄). In producing these compositions, the excess potassium (K/S>1.0) reacts with both KHSO₅ and KHSO₄, following an attrition close to their molar ratios. The decomposition of monopersulfate reduces the A.O. level in the resulting triple salt and increases sulfates.

Various parameters have been manipulated to optimize Caro's acid production. One of these parameters is reaction temperature. Temperature has been controlled to reduce the decomposition of Caro's acid, which results in release of oxygen and increase in sulfate salts, neither of which is desirable. Some knowledge regarding preparation of Caro's acid and PMPS triple salt are provided in the following references:

U.S. Pat. No. 3,939,072 (“the '072 patent”) teaches a process for point of use production of Caro's acid, in which the Caro's acid is cooled to between −10° C. to 80° C. to reduce decomposition of the Caro's acid before its use.

U.S. Pat. No. 5,141,731 (“the '731 patent”) teaches a process and an apparatus for point of use generation of peroxyacids by adding H₂O₂ to a stream of H₂SO₄ in multiple stages. The H₂SO₄ is cooled to between 15 to −40° C. before this addition. After the addition, the resulting solution is cooled to a temperature of 0 to 80° C. to reduce the decomposition of Caro's acid. The Caro's acid has to be diluted with water or used immediately thereafter, before decomposition of the Caro's acid happens. As in the '072 patent, the cool temperature is maintained to prevent A.O. loss that is generally caused by a higher temperature that results from the exothermic reaction. The resulting solution is reported to be 15% higher in H₂SO₅ when using multiple additions of H₂O₂ versus one addition. However, if the dilution with water or the use of the Caro's acid is not immediately done after the H₂O₂ addition, the equilibrium reaction takes place and the A.O. level rises to about 4.3. In lab experiments, Caro's acid solution is produced over a period of about 20 seconds, diluted with water to a solution strength of less than 200 g/l to stop the reactions, then chilled to preserve the Caro's acid for analysis. In practical use, the invention requires a series of stages wherein some amount of H₂O₂ is added to the oxyacid in each stage, mixed, and cooled.

This method illustrates that a higher percentage of H₂O₂ conversion can be achieved by controlling the order of addition of the reagents. However, the resulting Caro's acid solution must be used immediately after production as is the case utilizing the disclosed invention, or rapidly diluted with water in order to preserve the benefits of the invention. If not used or diluted immediately after its production, as disclosed in literature and prior art, the KHSO₅ portion of the Caro's acid solution will decompose to achieve the equilibrium product that is well established in the prior art, resulting in a triple salt having an A.O. of ≦4.3.

Another shortcoming of this method is that it is difficult to implement with the use of traditional single-stage reactors. This technique requires multiple series of reactors, each independent of the other, to provide a single pass process. Naturally, this process excludes the use of traditional single-stage reactors such as batch or stirred tank reactors since addition of the H₂O₂ requires substantially more time to complete the addition and reaction before application or dilution whereby the reactions, including the equilibrium reaction, are sequestered.

U.S. Pat. No. 5,429,812 (“the '812 patent”), which discloses a process of producing peroxysulfuric acid from substoichiometric levels of H₂SO₄ to H₂O₂, teaches using a substoichiometric amount of H₂SO₄ to produce an equilibrium amount of Caro's acid. The final mixture in the '812 patent has a molar ratio of SO₃ to Available Oxygen in the range of 0.8 to 0.2. The '812 patent also teaches that the order in which these reagents are introduced does not affect the Caro's acid yield. The reagents used were 70% H₂O₂ and 93% H₂SO₄. The '812 patent discloses that regardless of taking steps to avoid decomposition such as cooling and agitation, trials demonstrated that equilibrium occurred very quickly when the reactants were brought into contact, and that the position of the equilibrium depended consistently on the molar concentrations of the reactants, independently of the order of introduction.

As disclosed in the '812 patent, even with adequate cooling and agitation to prevent decomposition, the equilibrium proceeds rapidly and results with an A.O. value consistent with the established equilibrium products. This occurred regardless of the order of reactant addition and was independent of the reactant concentrations, which include H₂O concentration. Also, previously, it was known that using 70% H₂O₂ and H₂SO₄ will result in a Caro's acid solution with an active oxygen content of no greater than 4.3% at a 1:1 molar ratio.

U.S. Pat. No. 5,139,763 (“the '763 patent”) teaches making Caro's acid with a supra-stoichiometric molar amounts of oleum to H₂O₂. It discourages using H₂SO₄ on the grounds that a higher molar equivalent of H₂SO₄ is required to obtain similar yields of H₂SO₅ compared to oleum, resulting in a higher manufacturing cost. Also, when this high molar equivalent of H₂SO₄ is used, the molar ratio of the resultant solution has a H₂SO₅ to H₂SO₄ ratio that is less than what is desired for the preparation of the PMPS triple salt. The Caro's acid is partially neutralized to raise the K/S to 1.15-1.25, then combined with a solution richer in monopersulfate.

The method of the '763 patent involves many steps and results in an undesirably high concentration of K₂S₂O₈.

U.S. Pat. No. 5,607,656 (“the 656 Patent”) describes a process for producing PMPS with high available oxygen and a low concentration of K₂S₂O₈. This process involves reacting 20 to 70 wt. % strength oleum with 30 to 70 wt. % strength hydrogen peroxide to form Caro's acid, partially neutralizing the Caro's acid, then adding sulfuric acid and potassium hydroxide to the mixture by injection into the vacuum crystallizer while evaporating off the moisture. The resulting wet salt has a K₂S₂₀₈ concentration of less than 1.5 wt. %, which is reported to be less than that found in the commercially available triple salt. However, the commercial advantage of this process is limited by the increase in cost associated with all the additional reagents (higher SO₄ to H₂O₂ molar ratio) required to dilute the K₂S₂O₈ concentration in the triple salt, and the resulting A.O. as compared to the initial Caro's acid solution.

The '656 patent discloses a process for producing a triple salt with reduced oxodisulfate by reacting Caro's acid produced from oleum with additional H₂SO₄ and KOH. This dilution process utilizes established processing techniques as previously disclosed. Like other disclosures, the critical chemistry and control parameters are met to produce the resulting triple salt.

U.S. Pat. No. 4,579,725 (“the '725 patent”) describes a process for producing PMPS with high available oxygen and low K₂S₂O₈ by partially neutralizing the Caro's acid produced from 65-75% oleum and H₂O₂ by reacting the reagents at a sulfur to peroxide molar ratio of 0.9 to 1.2. The Caro's acid is reacted with KOH to achieve a K/S ratio <0.95. The resulting slurry is concentrated by using vacuum evaporation so that the fraction of the slurry solids is sustained at <40%. The mother liquor that is rich in KHSO₅ is recycled back to the evaporator. MgCO₃ is aggressively added to the concentrated slurry to control the K/S ratio to yield a product of high A.O. The MgCO₃ treatment is needed because the product has low-K/S product has low stability and melting point.

The '725 patent uses 65-75% oleum to produce Caro's acid, performs partial neutralization with KOH solution to achieve K/S ratio <0.95, concentrates using vacuum evaporation to slurry solids of <40%, forms a wet cake while returning concentrate back to the evaporator, adds MgCO₃ to the cake, mixes and dries, and adds more MgCO₃.

The resulting monopersulfate salt from the low K/S ratio is hygroscopic and unstable. Coating with MgCO₃ was shown to stabilize the salt. MgCO₃ has been used as an anti-caking agent to improve fluidity of the triple salt for many years.

U.S. Pat. No. 4,610,865 (“the 865 Patent”) discloses a process to produce and concentrate a solution containing KHSO₅ to a monopersulfate concentration of 20-30 wt. % KHSO₅, cooling a partial stream to <15° C. to precipitate the triple salt, filtering the triple salt, and drying.

Like the '725 patent, the '865 patent defines specific chemical and control parameters like those disclosed in the expired prior art patents mentioned above, to produce a composition of triple salt precipitated from a solution of KHSO₅ using a cold precipitation technique. The equipment and methods of producing the Caro's acid, triple salt, concentrating and separating are consistent with previously disclosed methods of processing.

The resulting monopersulfate, like that in the '725 patent, is produced from substoichiometric levels (excess sulfuric acid) of potassium to sulfur, and therefore is hygroscopic and exhibits poor shelf life.

All of the disclosed methods of producing a stable, non-hygroscopic (K/S>1.15) triple salt of reduced K₂S₂O₈ with high active oxygen (>4.7%) require additional treatment of the slurry streams, reprocessing of solutions of triple salt to dilute the K₂S₂O₈, and/or additional treatment steps to increase stability and melting point of the resulting triple salt. In doing so, waste streams of discarded inert salts such as K₂SO₄, and/or multiple processing steps, high recycle rates, and elaborate process control scenarios are proposed.

Because of the indirect nature of producing these hybrid triple salts, their commercial viability is severely impaired due to the increased production cost resulting from product waste (discarded salts) and/or extensive recycling and reprocessing of the triple salt solutions.

Thus, the search for a way to efficiently produce PMPS triple salt with less irritant byproducts (e.g., K₂S₂O₈) and higher active oxygen with a high stability at a reasonable cost continues.

### BRIEF DESCRIPTION OF THE DRAWINGS

FIG. 1 is a ternary diagram illustrating the compositions of triple salts produced according to currently known methods disclosed in the '763 patent (area enclosed by EGHJE and LMNOL).

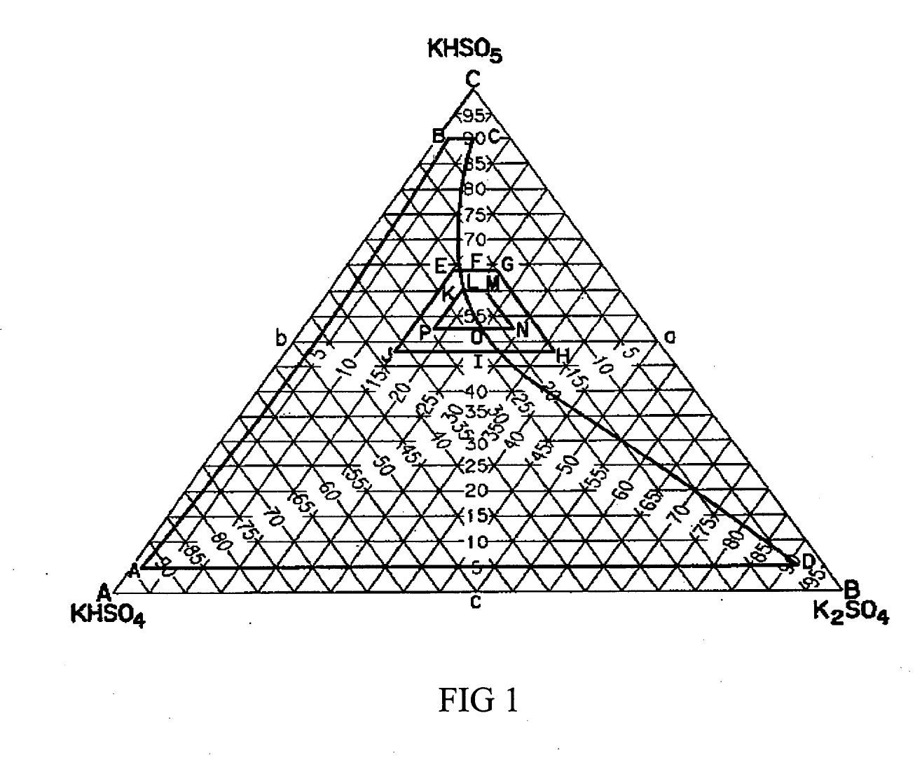

FIG. 2 is a ternary diagram illustrating the compositions of triple salts (EGXYE and EGQRE) produced in accordance with different embodiments of the invention.

FIG. 3 is an example illustrating a continuous process to produce the composition of the invention.

FIG. 4 is a flowchart illustrating a first embodiment of a method for producing PMPS triple salt with low K₂S₂O₈ and high A.O., in accordance with the invention.

FIG. 5 is a flowchart illustrating a second embodiment of a method for producing PMPS triple salt with low K₂S₂O₈ and high A.O., in accordance with the invention.

FIG. 6 is a flowchart illustrating a third embodiment of a method for producing PMPS triple salt with low K₂S₂O₈ and high A.O., in accordance with the invention.

### SUMMARY

The invention is a potassium monopersulfate composition having the formula (KHSO₅)x.(KHSO₄)y.(K₂ SO₄)z, where x+y+z=1, wherein the potassium monopersulfate composition contains an active oxygen content greater than or equal to 4.5 wt. % and K₂S₂O₈ at a concentration of <0.5 wt. % of the potassium monopersulfate composition. The K/S ratio of the composition is >1. The composition may be such that x=0.46−0.64, y=0.15−0.37, and z=0.15−0.37. The invention also includes a method of producing this potassium monopersulfate composition.

In one aspect, the method of the invention includes reacting an H₂O₂ solution with oleum at a substoichiometric ratio of SO₃: H₂O₂ to generate a first Caro's acid solution. The H₂O₂ solution contains at least 70 wt. % H₂O₂ and the oleum contains SO₃ and H₂SO₄. The first Caro's acid solution contains H₂SO₅, residual H₂O₂, and H₂O. The first Caro's acid solution is combined with an H₂SO₄ solution. The H₂SO₄ solution reacts with the H₂O in the first Caro's acid solution to produce a second Caro's acid solution. An alkali potassium compound is added to the second Caro's acid solution to achieve a partially neutralized solution, forming the potassium monopersulfate composition.

### DETAILED DESCRIPTION OF THE PREFERRED EMBODIMENT(S)

As used herein, a “peroxide solution” and a “sulfuric acid solution” refer to solutions of H₂O₂ and water, and H₂SO₄ and water, respectively. “Oleum” refers to free SO₃ dissolved in H₂SO₄. A “Caro's acid solution” refers to Caro's acid (H₂SO₅) mixed with one or more of H₂O₂, H₂O, and H₂SO₄. The terms “stabilizing” and “stabilized,” when used in reference to the Caro's acid solution, indicate the suppression of the equilibrium reaction, or suppression of Reaction 1b (see below) that converts the H₂SO₅ back to the reactants. A “stable” potassium monopersulfate composition, on the other hand, has an active oxygen loss of <1% per month. “Non-hygroscopic” means having a K:S ratio greater than 1.

A “weak” Caro's acid is Caro's acid with sub-stoichiometric molar ratio of H₂SO₄ to H₂O₂. A “rich” Caro's acid solution is a solution with an SO₄ molar ratio of greater than or equal to the H₂O₂ based on the reactants basis.

The rate of the reaction between H₂SO₅ and H₂O changes with temperature and with the order of reagent addition. Thus, by controlling the temperature and the order in which reagents are introduced to produce Caro's acid, a Caro's acid solution having an H₂SO₅ concentration that is substantially higher than that of currently available Caro's acid solutions can be produced. Furthermore, by shifting the reaction rate by manipulating temperature, the Caro's acid with high H₂SO₅ concentration can be stabilized. The stabilized Caro's acid solution may be used for various purposes, one of which is the production of the PMPS triple salt. The PMPS triple salt prepared with the high-H₂SO₅ Caro's acid solution has an A.O. level that is substantially higher than that of conventional PMPS triple salts.

Controlling the temperature in Caro's acid equilibrium reaction affects the rate of reaction. If the reactants are added in the right order under the right temperature to favor the formation of H₂SO₅, and if the resulting product is stabilized until all the reactants are added and the reaction is complete, Caro's acid production is optimized for high H₂SO₅ concentration. A Caro's acid solution having a higher molar ratio of KHSO₅/H₂SO₄ can be used to prepare a stable, non-hygroscopic PMPS triple salt composition that has an active oxygen greater than the reported maximum of 4.3% (e.g., the '731 patent). To prepare a useful version of the high-A.O. PMPS triple salt, the increased concentration of KHSO₅ has to be stabilized so that KHSO₅ does not decompose.

As stated above, Caro's acid is an equilibrium product of the following two equilibrium reactions:
H₂SO₄+H₂O₂→H₂SO₅+H₂O (Reaction 1a)
H₂SO₅+H₂O→H₂SO₄+H₂O₂ (Reaction 1b)
Reaction 1a is herein referred to as the “forward reaction,” and Reaction 1b is herein referred to as the “reverse reaction.” H₂SO₄+H₂O₂ are herein referred to as the “reactants.” As the water content increases, the rate of forward reaction decreases. Also, as the concentrations of the reactants become reduced due to the forward reaction, the rate of the forward reaction decreases.

Initially, when H₂O₂ is added to a solution of H₂SO₄, the molar ratio of H₂SO₄ is many times higher than the H₂O₂ and the rate of conversion in the forward reaction is high. When the temperature is kept to below or at 20° C., the rate of the reverse reaction (Reaction 1b) is suppressed, maintaining a high concentration of H₂SO₅. However, as the addition of H₂O₂ continues, the molar ratios of H₂O₂ and H₂SO₄ become closer to 1.0, the concentration of H₂O increases, and the rate of the forward reaction is reduced. Thus, while the initial rate of reactants' conversion to H₂SO₅ is higher than that achieved if H₂SO₄ were to be added to H₂O₂ or if both reactants were combined at once, the benefits of controlling the order of addition are lost with time due to the effects of the reverse reaction (this was illustrated in the '812 patent). The reverse reaction ultimately lowers the active oxygen level in the PMPS triple salt that is produced with the resulting Caro's acid solution. Thus, measures are needed to stabilize the high-H₂SO₅ solution and suppress the reverse reaction.

The '072 patent and the '731 patent teach using or diluting the Caro's acid solution immediately, before the effect of the reverse reaction becomes significant. However, because the reverse reaction quickly begins to take place, it is difficult to complete the dilution process before the reverse reaction takes place, at least with the typical batch and stirred tank reactors. Whereas maintaining the temperature at or below 80° C. is sufficient to reduce the decomposition of the Caro's acid before its application in point-of-use applications, this temperature control method is impractical when the reactant addition and dilution are done in a single stage. For example, a batch reactor, a stirred tank reactor, or a thin-film reactor, which are frequently used for single-stage reactions, require considerable time for reactant additions and completion of the reactions that the reverse reaction would have already been triggered by the time the reagent addition is complete. Without means of stabilizing the H₂SO₅ portion of the Caro's acid, the equilibrium is rapidly achieved (as disclosed in '812). The equilibrium occurs despite the efforts of cooling the temperature adequately to reduce the decomposition of H₂SO₅.

Oleum, which is rich in SO₃, may be added to the H₂O₂ to convert water present in the peroxide solution since reducing the water concentration helps drive the forward reaction. Oleum also consumes some of the water that is released from the peroxide during the forward reaction. The reaction of oleum and water proceeds as follows:
H₂O+SO₃>>>H₂SO₄ (Reaction 2)
As the molar ratio of oleum to H₂O₂ approaches 1.0, the ratio of free H₂O to SO₃ is significantly reduced, and SO₃ begins reacting directly with H₂O₂ as illustrated by the following formula:
2SO3+H₂O₂>>>H₂S₂O₈ (Reaction 3)
The production of H₂S₂O₈ is undesirable, as it may ultimately result in the formation of the irritant K₂S₂O₈.

In order to achieve high active oxygen, sufficient oleum is added to convert as much of the H₂O₂ as is economically permitted. As discussed in many of the prior art patents, the molar ratio of sulfur from oleum to peroxide is generally 1.1 to 1.6, with 1.18 being frequently recited.

As illustrated in the '725 patent, in order to prevent or eliminate K₂S₂O₈, elaborate process control to balance the slurry chemistry between recycled mother liquor and neutralized Caro's acid solutions are required. Also, other methods are proposed involving reprocessing triple salt solution by treatment with alkali potassium salts to precipitate and remove unwanted K₂SO₄, thereby enriching the KHSO₅ content, or adding additional H₂SO₄ with KOH to the triple salt solution as in the '656 patent, thereby diluting the K₂S₂O₈.

In order to produce a stable, non-hygroscopic triple salt composition high in A.O. with substantially no K₂S₂O₈, several criteria must be met. First, it is desirable to stabilize H₂SO₅ immediately after its formation, to prevent reversion back to the reactants H₂SO₄ and H₂O₂ according to the reverse reaction of Reaction 1b. Second, residual (free) H₂O must be minimized to maximize the yield in H₂SO₅. This can be accomplished by using reactants in the highest range of activity as possible.

Where oleum is used in any of the reaction steps, the feed-rate of oleum, and molar ratio of oleum to H₂O₂ must be controlled within specific guidelines to prevent formation of H₂S₂O₈ by the reaction of Equation 3 above.

The invention includes novel methods of producing a highly stable, nonhygroscopic potassium monopersulfate composition with high active oxygen and substantially no detectable K₂S₂O₈. Thus far, the prevalent belief was that the order of reactant introduction does not affect the reaction outcome when potassium monopersulfate is made with a supra-stoichiometric to stoichiometric molar ratio of H₂SO₄ to H₂O₂. Once a method of stabilizing the H₂SO₅ has been developed, various unique methods of processing Caro's acid and its resulting triple salt can be used to produce compositions of high available oxygen with substantially reduced K₂S₂O₈.

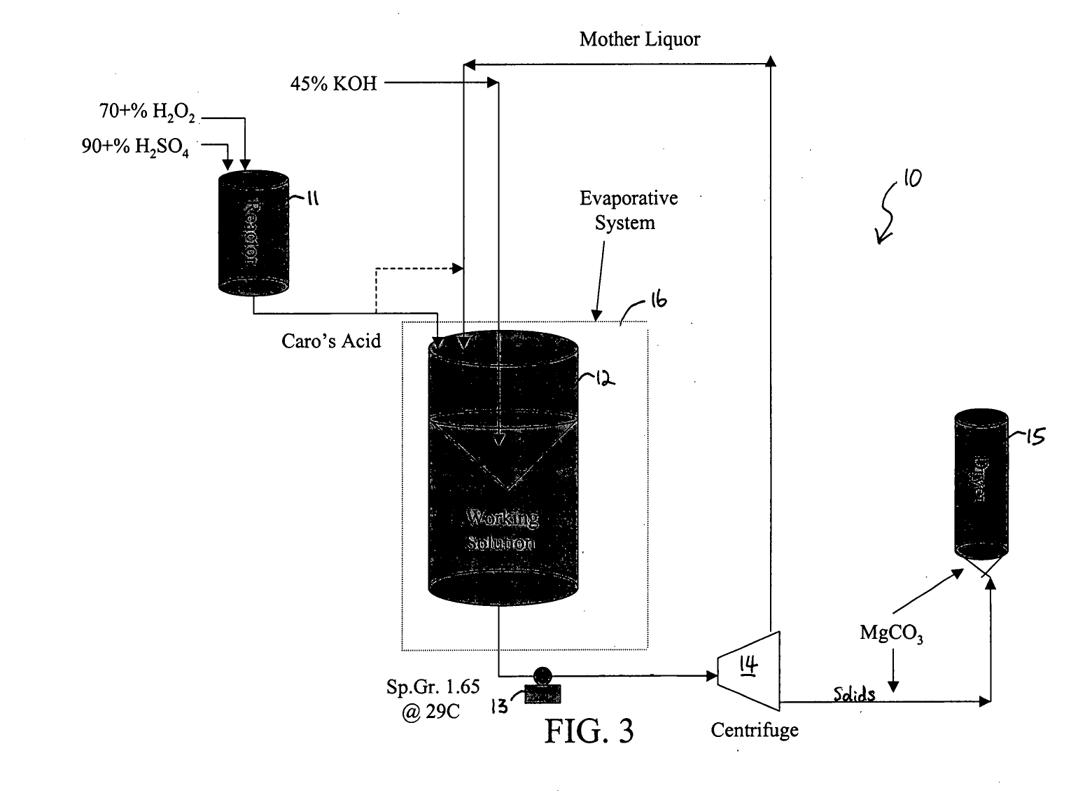

FIG. 3 is a continuous single-pass process that may be used to implement the invention. The single-pass process system 10 includes a reactor 11 where the sulfur source solution (e.g, H₂SO₄ solution, oleum solution) and the peroxide solution are reacted to generate Caro's acid. In addition, the system 10 includes a working tank 12, a slurry pump 13, a centrifuge 14, and a dryer 15. The Caro's acid generated in the reactor 11 is combined with an alkali potassium salt in the working tank 12 to generate the PMPS triple salt, which is in the form of a slurry. The slurry containing the triple salt is pumped by the slurry pump 13 into the centrifuge 14, which separates the slurry into solids and mother liquor. The slurry contains at least 30 wt. % solids, as determined by the specific gravity of the slurry being greater than 1.55 at 29° C., and preferably being 1.65 at 29° C. The mother liquor is recycled back into the working tank 12. The mixture of the recycled mother liquor, the Caro's acid, the alkali potassium salt, and the slurry in the working tank 12 is herein referred to as the “working solution.” The working solution is concentrated by being mixed in a vacuum evaporator 16 at a temperature less than or equal to 35° C.

As shown, the solids coming out of the centrifuge 14 are placed in the dryer 15. The solids are dried, preferably at a temperature below 90° C. and more preferably at a temperature below 70° C., to produce the potassium monopersulfate triple salt.

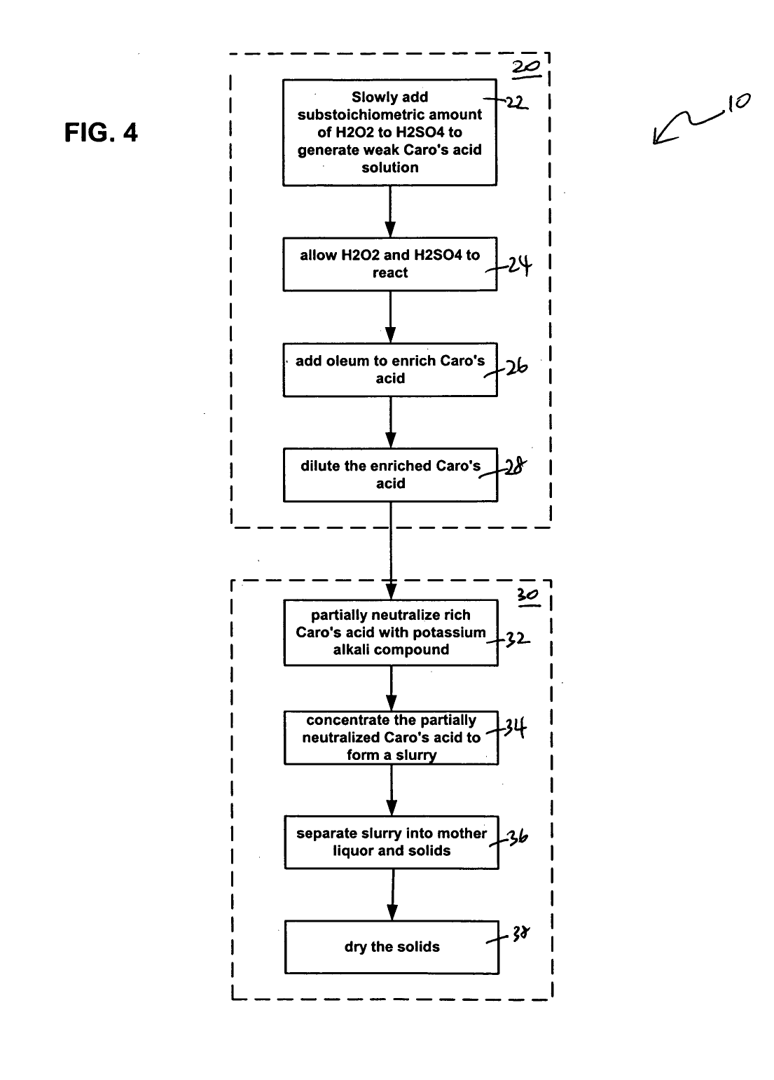

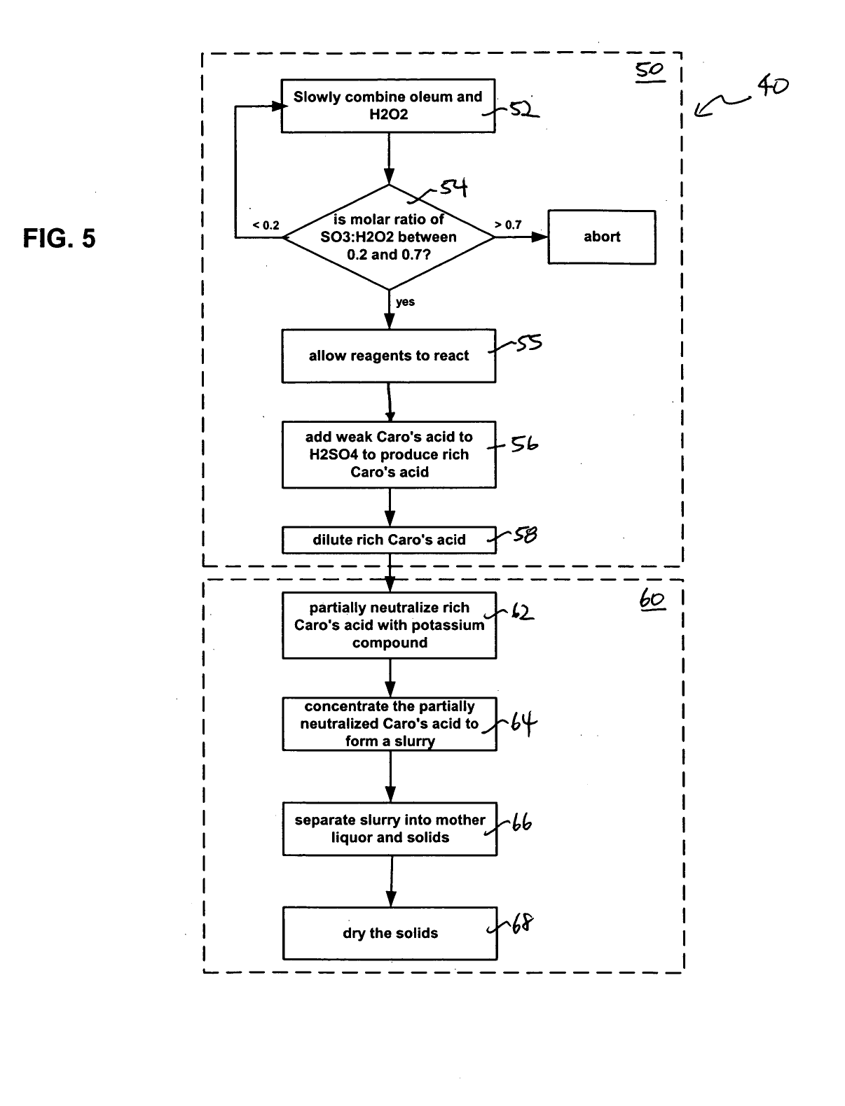

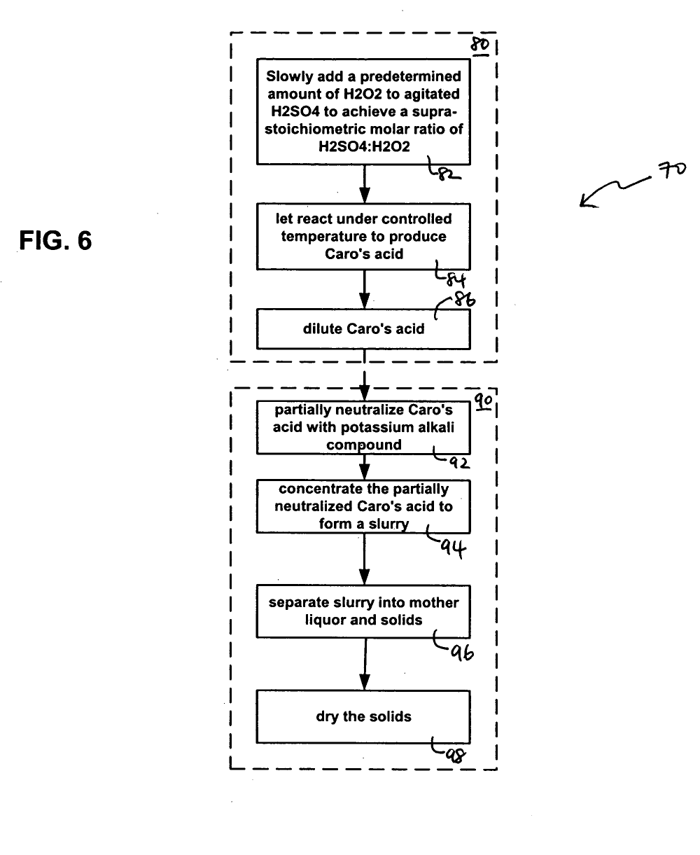

Three embodiments of the invention are presented herein, and the methods of producing a rich Caro's acid are different in the three embodiments. The first embodiment, which is illustrated in FIG. 4, includes addition of H₂O₂ to H₂SO₄ at a substoichiometric ratio of H₂SO₄: H₂O₂ followed by addition of oleum. The second embodiment, which is illustrated in FIG. 5, includes reaction between oleum and H₂O₂ at a SO₃: H₂O₂ ratio in the range of about 0.2˜0.7, followed by addition of the resultant Caro's acid to H₂SO₄. The third embodiment, which is illustrated in FIG. 6, includes addition of H₂O₂ to H₂SO₄ at supra-stoichiometric ratio of H₂SO₄: H₂O₂. The rich Caro's acid solution is diluted with water while controlling the resulting mixture's temperature at <18° C., preferably <10° C. The resulting mixture is then partially neutralized with a solution of alkali potassium salt to raise the K/S ratio of between 1.10 to 1.25. The optimum K/S ratio is dependent on which method is used to produce the Caro's acid.

Embodiment 1

The Caro's acid composition resulting from controlling the order of reactant addition (i.e., H₂O₂ to H₂SO₄) and thereby obtaining a supra-stoichiometric to stoichiometric ratio of H₂SO₄ to H₂O₂, results in a higher active oxygen content from H₂SO₅. The resulting Caro's acid solution can be stabilized to maintain a high H₂SO₅ concentration. By reducing the reverse reaction between H₂SO₅ and H₂O, a Caro's acid solution is produced which, upon partial neutralization with an alkali potassium, produces a PMPS triple salt having a K/S ratio of between 1.15 to 1.25. Such PMPS triple salt has an active oxygen higher than that of PMPS triple salt made with conventional methods, and does hot suffer from the drawbacks of K₂S₂O₈ formation.

Upon slow continuous or incremental addition of H₂O₂ and/or Caro's acid solution to H₂SO₄ under a temperature at or below 20° C., the rate of the forward reaction is initially high due to the excess H₂SO₄ and low H₂O concentration. With continued addition of H₂O₂, the H₂SO₅ converts back to H₂SO₄. However, the controlled temperature suppresses the rate of conversion of H₂SO₅ even as the H₂O concentration increases. The reversion rate is sufficiently reduced to allow for the benefits provided by the order of reactant addition to be utilized in the production of a triple salt composition. The resulting triple salt is substantially higher in A.O. than the conventional triple salt.

FIG. 4 is a flowchart of a first stabilized triple salt production process 10 in accordance with the invention. The first stabilized triple salt production process 10 includes a first Caro's acid production process 20 and a conversion and separation process 30. In the first Caro's acid production process 20, an H₂O₂ solution is slowly (e.g., incrementally) added to an H₂SO₄ solution, maintaining a substoichiometric ratio of H₂SO₄: H₂O₂ (step 22). Preferably, the H₂O₂ solution has a H₂O₂ concentration >70%. This slow addition increases the conversion of H₂O₂ to H₂SO₅ and increases the release of bound H₂O from the H₂O₂. As a result, there is more free H₂O in the solution. The resulting weak Caro's acid still contains residual H₂O₂ and free H₂O, which lead to a higher active oxygen content. The amount of residual H₂O₂ is minimized by stopping its addition as soon as the stoichiometric molar ratio of H₂SO₄: H₂O₂ is reached or exceeded. The H₂O₂ and the H₂SO₄ are allowed to react for at least 0.1 hours (step 24).

Then, oleum is added (step 26) to the weak (i.e., sub-stoichiometric molar ratio of total H₂SO₄ to H₂O₂) Caro's acid solution, which still contains residual H₂O₂ and free H₂O, to raise the molar ratio of SO₄ to H₂O₂ to at least the stoichiometric level. Upon the addition of oleum, the free H₂O reacts with SO₃, per Reaction 2. By minimizing residual H₂O₂, formation of H₂S₂O₈ per Reaction 3 is minimized. After step 26, a rich Caro's acid is produced. The rich Caro's acid is optionally diluted (step 28). Temperature is maintained at a level <20° C. throughout the process 20 to stabilize the H₂SO₅.

The rich Caro's acid is subjected to the process 30 to form a PMPS triple salt with high A.O. and a substantially reduced amount of K₂S₂O₈ compared to the conventional triple salts. The diluted Caro's acid solution is partially neutralized with an alkali potassium compound (step 32) to achieve a K/S ratio greater than 1, preferably between 1.10 to 1.25. The partially neutralized solution is concentrated to form a slurry (step 34), for example by mixing in a vacuum evaporator. The slurry is then separated into mother liquor and solids (step 36), wherein the solids contain the desired PMPS composition. The solids are dried (step 38), preferably at a temperature <90° C. and more preferably at a temperature <70° C., to obtain a PMPS composition that does not have much H₂O. The resulting PMPS composition has an active oxygen content higher than 4.3 and has substantially no irritant (K₂S₂O₈).

1. First Example of Embodiment 1

28.54 g of 70% H₂O₂ (approx. 0.59 mol H₂O₂) was added drop-wise to 60.02 g of vigorously agitated 93% H₂SO₄ (approx. 0.57 mol H₂SO₄) while controlling the temperature with an ice/brine solution between 5-8° C. The addition took 2.5 hrs and produced a Caro's acid solution from almost a 1:1 molar ratio of H₂SO₄ to H₂O₂.

The Caro's acid solution was allowed to react with vigorous agitation for 60 minutes while the temperature was controlled between 2-5° C.

The Caro's acid solution was diluted with 47.5 g deionized H₂O by addition of the Caro's acid to the water with vigorous agitation while controlling the temperature between 10-15C.

48.78 g K₂CO3 was diluted with 66.98 g deionized H₂O. This solution was added drop-wise to the vortex of the vigorously agitated solution of diluted caro's acid to raise the K/S ratio to 1.2. Temperature was varied between 11-17° C. Total lapsed time to complete the addition was 18 minutes.

The solution was transferred to a glass evaporation tray and placed on a hot plate. A fan was used to increase air circulation and reduce the pressure above the solution. The temperature was controlled between 28-30° C. while continuous mixing was applied.

After 1.75 hrs, the solution was concentrated to a thick paste. The paste was spread across the tray and the temperature was increased to induce drying. The triple salt was periodically mixed and crushed to increase the efficiency of drying. The resulting triple salt had an A.O. content of 4.82% and 0.0% K₂S₂O₈.

This Example illustrates that a triple salt composition having an increase in A.O. of 12% greater than that expected from the anticipated equilibrium products from a 1:1 molar ratio of 96% H₂SO₄ to 70% H₂O₂ by use of the invention. Also, it has been demonstrated that by utilizing the disclosed invention, 80% of the increased H₂SO₅ proposed in '731 is stabilized and recovered in the form of KHSO₅. These results clearly demonstrate that the rate of the equilibrium reaction can be suppressed to benefit from the supra-stoichiometric ratio induced by the order of reactant addition for the formation of a triple salt composition.

2. Second Example of Embodiment 1

20.54 g of 76% H₂O₂ (approx. 0.46 mol H₂O₂) was slowly added to 10.02 g 98% H₂SO₄ (approx. 0.1 mol H₂SO₄).

46.67 g of 26% oleum was slowly added through a drip tube to the weak Caro's acid over a period of 1.5 hours.

The temperature was maintained at between −2 to 8° C. during both steps of the Caro's acid production.

The rich The rich Caro's acid solution was added to 47.23 g deionized H₂O while controlling the temperature between 0-6° C.

48.89 g K₂CO3 was diluted with 59.95 g of deionized H₂O and slowly added to the vortex of the rich Caro's acid, K/S 1.18.

The solution was concentrated using evaporation techniques described in the previous examples to a thick paste. 1.02 g magnesium carbonate hydroxide pentahydrate was added, then the solids were dried.

The resulting triple salt was 6.3% A.O. and 0.0% K₂S₂O₈.

This Example illustrates that H₂O bound in the H₂O₂ can be effectively released by utilizing the steps of the invention, then reacted with SO₃ in the oleum to produce a triple salt free of K₂S₂O₈.

3. Third Example of Embodiment 1

Add a supra-stoichiometric ratio of 70-99.6% H₂O₂ to agitated 90-100% H₂SO₄ while controlling the temperature at <20° C., and preferably <15° C., and more preferably ≦10° C. The resulting weak Caro's acid solution is converted to a rich Caro's acid solution by slowly or incrementally adding to a solution of 1-75% oleum while controlling the temperature at ≦20° C., preferably ≦15° C., and more preferably ≦10° C. to produce a rich Caro's acid solution.

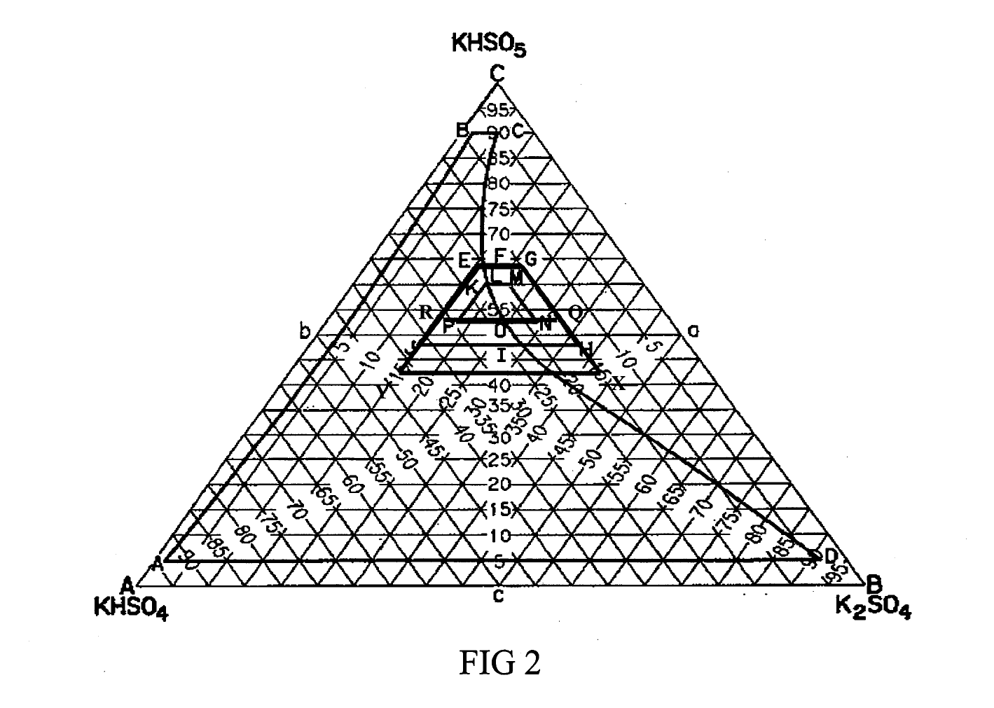

The partially neutralized triple salt resulting from the use of the resulting Caro's acid is further processed to produce a nonhygroscopic triple salt defined by the enclosed curve EGXYE, and more specifically EGHJE in FIG. 2 with <0.1 wt % K₂S₂O₈, and having the general formula: (KHSO₅)x.(KHSO₄)y.(K₂SO₄)z, where x+y+z=1 and x=0.53−0.64, y=0.15−0.33, and z=0.15−0.33.

Embodiment 2

FIG. 5 is a flowchart of a second stabilized triple salt production process 40 in accordance with the invention. The second stabilized triple salt production process 40 includes a second Caro's acid production process 50 and a conversion and separation process 60. In the second Caro's acid production process 40, oleum is combined with H₂O₂ at a substoichiometric molar ratio of oleum: H₂O₂ (step 52). In contrast to Embodiment 1, the order of reagent introduction is not as important in Embodiment 2, and either reagent may be added to the other. The addition of the reagent stops when the molar ratio of SO₃ to H₂O₂ is between about 0.2 and about 0.7 (step 54). If this molar ratio range is accidentally passed, it is preferable to start the process over again. By maintaining the SO₃: H₂O₂ molar ratio within the range of about 0.2˜0.7, inclusive, the concentration of H₂S₂O₈ is maintained at a low level. Once all the reagents are combined, let the reagents react for at least 0.1 hour (step 55) under a temperature at or below 20° C.

The free H₂O is partially consumed by the SO3, per Reaction 2. The resulting weak Caro's acid, which contains residual H₂O₂, is slowly added to the H₂SO₄ to further benefit from the higher conversion offered by controlling the order of addition of reagents (step 56). By using substoichiometric ratios of oleum: H₂O₂ to consume H₂O, and then applying the resulting Caro's acid solution to H₂SO₄, a rich Caro's acid solution is produced. The partially neutralized Caro's acid solution is diluted, if needed (step 58).

The diluted Caro's acid solution is subjected to the PMPS composition formation process 60. The diluted Caro's acid solution is first partially neutralized by addition of a potassium alkali compound (step 62) to achieve a K/S ratio greater than 1. The partially neutralized solution is concentrated to form a slurry (step 64), for example by mixing in a vacuum evaporator. The slurry is then separated into mother liquor and solids (step 66), wherein the solids contain the desired PMPS composition. The solids are dried (step 68), preferably at a temperature <90° C. and more preferably at a temperature <70° C., to obtain a PMPS composition that does not have much H₂O. The resulting PMPS composition has an active oxygen content higher than 4.3 and has substantially no irritant (K₂S₂O₈).

1. First Example of Embodiment 2

50.14 g of 20% oleum was slowly added through a drip tube to 22.35 g of 76% H₂O₂ over a period of 2.5 hours with vigorous mixing. The weak Caro's acid was allowed to react for 30 minutes. The weak Caro's acid solution was then slowly added to 10.06 g of 98% H₂SO₄ while controlling the temperature between 0-8° C. The rich Caro's acid solution was allowed to react for 45 minutes.

The rich Caro's acid solution was added to 47.81 g of deionized H₂O while controlling the temperature to between 6-9° C. 50.37 g of K₂CO₃ was dissolved in 61.75 g of deionized H₂O and slowly added drop-wise to the vortex of the diluted Caro's acid while controlling the temperature between 15-20° C., K/S 1.15.

The solution was evaporated using the techniques described in the previous examples to produce a thick past. The sample (approximately 90 g) was treated with 1 g of magnesium carbonate hydroxide pentahydrate and dried. The resulting treated triple salt had an A.O. of 6.46% and 0.0% K₂S₂O₈.

This Example illustrates that a commercially available 20% oleum can be reacted substoichiometric with peroxide to produce a weak Caro's acid substantially free of H₂S₂O₈. The weak Caro's acid is then reacted with H₂SO₄ inducing a supra-stoichiometric ratio of SO₄ to H₂O₂, resulting in a rich Caro's acid solution, which is then processed to produce a triple salt having high A.O. and no measurable K₂S₂O₈.

2. Second Example of Embodiment 2

A substoichiometric ratio of 1-75% oleum is added to an agitated solution of 70-90% H₂O₂ while controlling the temperature at ≦25° C., preferably at ≦15° C., and more preferably at ≦10° C. The resulting weak Caro's acid solution is slowly or incrementally added to a solution of agitated H₂SO₄ while controlling the temperature at ≦20° C., preferably ≦15° C., and more preferably ≦10° C. to produce a rich Caro's acid solution.

The partially neutralized triple salt resulting from the use of Caro's acid produced according to Embodiment 2 is further processed to produce a nonhygroscopic triple saltdefined by the enclosed curve EGXYE, and more specifically EGHJE in FIG. 2 with <0.1 wt % K₂S₂O₈, and having the general formula: (KHSO₅)x.(KHSO₄)y.(K₂SO₄)z, where x+y+z=1 and x=0.53−0.64, y=0.15−0.33, and z=0.15−0.33.

Embodiment 3

FIG. 6 is a third triple salt production process 70, which includes a third Caro's acid production process 80 and a conversion and separation process 80. Slowly (continuously or incrementally) add H₂O₂ to an agitated H₂SO₄ solution to induce a supra-stoichiometric molar ratio of H₂SO₄ to H₂O₂ (step 82). As more H₂O₂ is added, the molar ratio of H₂SO₄/H₂O₂ decreases. Stop adding H₂O₂ when the final ratio is stoichiometric or substoichiometric. Then, let the reagents react for at least 0.1 hour (step 84) to form Caro's acid before diluting the Caro's acid (step 86). The dilution may be with water or a mother liquor recycled from the process 90.

The diluted Caro's acid is partially neutralized with a potassium alkali compound (step 92) to achieve a K/S ratio greater than 1, preferably between 1.10 to 1.25. The partially neutralized solution is concentrated to form a slurry (step 94), for example by mixing in a vacuum evaporator. The slurry is then separated into mother liquor and solids (step 96), wherein the solids contain the desired PMPS composition. The solids are dried (step 98), preferably at a temperature <90° C. and more preferably at a temperature <70° C., to obtain a PMPS composition that does not have much H₂O. The resulting PMPS composition has an active oxygen content higher than 4.3 and has substantially no irritant (K₂S₂O₈).

1. First Example of Embodiment 3

22.03 g of 76% H₂O₂ (approx. 0.49 mol of H₂O₂) was added drop-wise to 60.02 g of vigorously agitated 98% H₂SO₄ solution (approx. 0.6 mol of H₂SO₄) while controlling the temperature with an ice/brine solution between 5-13° C. The addition took 0.5 hrs.

The Caro's acid solution was allowed to react with vigorous agitation for 1.25 hrs while the temperature was controlled between 2-5° C. in an ice/brine solution.

The Caro's acid solution was diluted with 47.17 g deionized H₂O by addition of the Caro's acid to the water with vigorous agitation while controlling the temperature between 10-12C.

47.78 g K₂CO₃ was diluted with 66.16 g of deionized H₂O. This solution was added drop-wise to the vigorously agitated solution of diluted Caro's acid to raise the K/S ratio to 1.20. The temperature was varied between 10-15° C. The resulting solution was separated into Sample 1 and Sample 2.

Sample 1 was transferred to a glass evaporation tray and placed on a hot plate. A fan was used to increase air circulation and reduce the pressure above the solution. The temperature was controlled between 28-30° C. while continuous mixing was applied. The solution was concentrated to a thick paste. The paste was spread across the tray and the temperature was increased to induce drying. The triple salt was periodically mixed and crushed to increase the efficiency of drying. The resulting triple salt had an A.O. content of 5.35% and 0.0% K₂S₂O₈.

This Example illustrates that utilizing point of use concentration of hydrogen peroxide to raise the peroxide to >70%, approximately a 1:1 molar ratio as in example 1 that employs the methods of the disclosed invention results in a triple salt having substantially increased A.O. without any detectable levels of K₂S₂O₈.

2. Second Example of Embodiment 3

Sample 2 was concentrated using the evaporation techniques used in Sample 1 until a heavy precipitate formed. The specific gravity was determined to be 1.87, which correlated to a slurry solids content of 65 wt. %. The resulting slurry was filtered and dried. The resulting triple salt had an A.O. of 5.38 and 0.0% of K₂S₂O₈.

This Example illustrates that a slurry concentrated to a desired specific gravity, separated and dried, can be effectively used to produce a product of higher A.O. without K₂S₂O₈.

3. Third Example of Embodiment 3

The H₂O₂ solution has an active content of 70-99.6 wt. % and the H₂SO₄ solution has an active content of 90-100 wt. %. During the addition of the H₂O₂ solution, the solution is maintained at a temperature ≦20° C., and preferably ≦15° C., and more preferably ≦10° C. The Caro's acid solution is mixed for about 0.01-1 hours thereafter before dilution. These process steps can take place under vacuum, or at or above atmospheric pressure.

The partially neutralized triple salt resulting from the use of Caro's acid thus produced is further processed to produce a nonhygroscopic triple salt defined by the enclosed curve JHXYJ in FIG. 2 with <0.1 wt % K₂S₂O₈, and having the general formula: (KHSO₅)x.(KHSO₄)y.(K₂SO₄)z, where x+y+z=1 and x=0.43−0.64, y=0.15−0.43, and z=0.15−0.43.

Because of increased environmental restrictions and the limited availability of enriched oleum (i.e. >30%), hydrogen peroxide was concentrated to >70% using point of use vacuum evaporation of commercially available 50 or 70% technical grade hydrogen peroxide. This process is readily transferable for commercial production of the triple salts of the invention. By utilizing point of use concentrating of commercially available peroxide, transportation, handling and storage, and the high cost of >70% peroxide is all but eliminated. This practice allows for greater flexibility in preparation of the various composition, as well as use of oleum products of ≦30% for most compositions resulting from the disclosed invention.

Of greatest significance and benefit of using the methods of the disclosed invention is the direct front-end production of a Caro's acid solution substantially free of H₂S₂O₈ for the production of a triple salt composition high in A.O. and substantially reduced K₂S₂O₈.

By producing a Caro's acid solution that is substanially free of H₂S₂O₈, the tail-end reprocessing of the triple salt as disclosed in the prior art is no longer needed. Reprocessing of the triple salt slurry and/or discarding removed inert salts of the triple salt required to either dilute the K₂S₂O₈ and/or enrich the KHSO₅ concentrations of the final triple salt composition. Also, this inventions allows for the direct production of a non-hygroscopic triple salt that has a K/S ratio of greater than 1.10, resulting in a stable triple-salt with a melting point of greater than 90° C. without the need for further treatment to improve melting point or product stability.

The increased A.O. with no H₂S₂O₈ can be efficiently produced in the earliest stages of production in a direct once-thru manner. The resulting neutralized Caro's acid solution provided from this invention can be directly processed to produce a triple salt product of high A.O. and substantially reduced K₂S₂O₈, thereby reducing waste of discarded salts, reducing equipment size to handle large recycles, energy from high recycle rates, and performing laborious chemical control checks and adjustments.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention.

1. A method of preparing a stable, non-hygroscopic potassium monopersulfate composition, the method comprising:
reacting an H₂O₂ solution with oleum at a substoichiometric ratio of SO₃: H₂O₂ to generate a first Caro's acid solution, wherein the H₂O₂ solution contains at least 70 wt. % H₂O₂, the oleum contains SO₃ and H₂SO₄, and the first Caro's acid solution contains H₂SO₅, residual H₂O₂, and H₂₀;
combining the first Caro's acid solution with an H₂SO₄ solution, wherein the H₂SO₄ solution reacts with the residual H₂O₂ in the first Caro's acid solution to produce a second Caro's acid solution;
adding an alkali potassium compound to the second Caro's acid solution to achieve a partially neutralized solution containing a potassium monopersulfate composition of the formula (KHSO₅)x.(KHSO₄)y.(K₂ SO₄)z, where x+y+z=1 and x=0.46−0.64, y=0.15−0.37, and z=0.15−0.37, said potassium monopersulfate composition having an active oxygen content greater than or equal to 4.9 wt. % and K₂S₂O₈ at a concentration of <0.5 wt. % of the potassium monopersulfate composition.

2. The method of claim 1, wherein the oleum comprises about 1-70 wt. % SO₃.

3. The method of claim 1, wherein combining the first Caro's acid solution with the H₂SO₄ solution comprises adding the first Caro's acid solution to the H₂SO₄ solution.

4. The method of claim 1, wherein the H₂O₂ solution contains about 70 wt. % to about 90 wt. % H₂O₂.

5. The method of claim 1 further comprising diluting the second Caro's acid solution with H₂O to produce a diluted second Caro's acid solution having an H₂SO₅: H₂SO₄ molar ratio of at least about 2.0 and a water content of about 40 to about 65 wt. %.

6. The method of claim 5 further comprising maintaining a temperature lower than 25° C. during the diluting of the second Caro's acid solution.

7. The method of claim 5 further comprising maintaining a temperature lower than 15° C. during the diluting of the second Caro's acid solution.

8. The method of claim 1 further comprising mixing the first Caro's acid solution for 0.1 to 2 hours before the combining with the H₂SO₄ solution.

9. The method of claim 1, wherein the combining comprises adding the first Caro's acid solution to an agitated H₂SO₄ solution at a temperature <15° C.

10. The method of claim 1 further comprising sustaining an average temperature at or below 20° C. after the combining.

11. The method of claim 1, wherein the H₂SO₄ solution comprises 90-100 wt % H₂SO₄.

12. The method of claim 1 further comprising maintaining the first Caro's acid solution at a temperature of <25° C. during production of the first Caro's acid solution.

13. The method of claim 1 wherein the first Caro's acid solution is maintained at a temperature of <15° C. during the forming of the first Caro's acid solution.

14. The method of claim 1 wherein the molar ratio of oleum to H₂O₂ is <0.7.

15. The method of claim 1 further comprising concentrating the partially neutralized solution by mixing the partially neutralized solution and applying vacuum evaporation to produce a slurry containing the potassium monopersulfate composition and H₂O.

16. The method of claim 15, wherein the concentrating of the partially neutralized solution is performed under vacuum at a temperature less than 35° C.

17. The method of claim 15, wherein the concentrating is done under vacuum at a temperature less than 30° C.

18. The method of claim 15 further comprising drying the slurry at a temperature less than 90° C.

19. The method of claim 15 further comprising drying the slurry at a temperature less than 70° C.

20. The method of claim 1 further comprising maintaining a temperature is below 30° C. during the adding of the potassium alkali compound.

21. The method of claim 1 further comprising maintaining a temperature is below 20° C. during the adding of the potassium alkali compound.

22. The method of claim 1, wherein the second Caro's acid solution has an SO₄:H₂O₂ molar ratio of between about 1:1 and about 1.6:1.

23. The method of claim 1 further comprising:
diluting the second Caro's acid solution to produce a diluted second Caro's acid solution containing no more than 60 wt. % Caro's acid solution and having a H₂SO₅:H₂SO₄ molar ratio of at least about 2.0.

24. The method of claim 23 further comprising:
concentrating the partially neutralized solution by mixing the partially neutralized solution in a vacuum evaporator to produce a slurry containing the potassium monopersulfate composition;
separating the slurry into solids and mother liquor; and
drying the solids to produce the potassium monopersulfate composition substantially free of H₂₀.

25. The method of claim 24, wherein a concentration of the solids in the slurry is determined by measuring the slurry's specific gravity.

26. The method of claim 24, wherein a concentration of the solids in the slurry is determined by achieving a specific gravity >1.55 measured at 29° C.

27. The method of claim 24, wherein the mother liquor is returned to the vacuum evaporator.

28. The method of claim 23, wherein the H₂O₂ solution contains between about 70 wt. % and about 90 wt % H₂O₂.

29. The method of claim 23 wherein the temperature of the first Caro's acid solution during the combining of the first Caro's acid solution with the H₂SO₄ solution is <25° C.

30. The method of claim 23, wherein the temperature of the first Caro's acid solution during the combining of the first Caro's acid solution with the H₂SO₄ solution is <15° C.

31. The method of claim 23, wherein the molar ratio of SO₃ to H₂O₂ is <0.9.

32. The method of claim 23, wherein the first Caro's acid solution is added to an agitated solution of H₂SO₄ while sustaining a temperature of <20° C.

33. The method of claim 23, wherein the first Caro's acid solution is added to an agitated solution of H₂SO₄ while sustaining a temperature of <15° C.

34. The method of claim 23, wherein the first Caro's acid solution is added to an agitated solution of H₂SO₄ while sustaining a temperature of <10° C.

35. The method of claim 1 further comprising maintaining a temperature of the first Caro's solution at or below 20° C.

36. The method of claim 1, wherein the potassium monopersulfate composition has a K:S molar ratio >1.

37. The method of claim 1, wherein the alkali potassium compound is added in the form of a solution.

38. The method of claim 1, wherein the alkali potassium compound is selected from a group consisting of K₂CO₃, KHCO₃, and KOH.

39. The method of claim 1 further comprising maintaining a temperature at or below 30° C. during the adding of the alkali potassium compound to the second Caro's acid.

40. The method of claim 1 further comprising maintaining a temperature at or below 20° C. during the adding of the alkali potassium compound to the second Caro's acid.

41. The method of claim 1, wherein the potassium monopersulfate composition has a K₂S₂O₈ concentration of <0.1 wt. % of the composition.
